(19) United States
(12) Patent Application Publication
(10) Pub. No.: US 2003/0231895 A1
(43) Pub. Date: Dec. 18, 2003

(54) Image forming system and download method in the image informing system

(75) Inventors: Tsuyoshi Seto, Ebina-shi (JP); Yoshinobu Nakamura, Ebina-shi (JP); Keiji Sawada, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/283,114

(22) Filed: Oct. 30, 2002

(30) Foreign Application Priority Data
Jun. 17, 2002 (JP) 2002-175240

(51) Int. Cl. G03G 15/00

(52) U.S. Cl. 399/75; 399/77

(57) ABSTRACT

In the image forming apparatus, when a RECEIVE PROCESSING UNIT receives program data downloaded from the outside, a transfer control unit judges whether the program data corresponds to the peripheral device connected to the image forming apparatus by comparing a type of the peripheral device identified by a peripheral device identification unit and the type of the peripheral device which can be specified with the downloaded program data. The transfer control unit judges that the program data is program data which corresponds to the connected peripheral device and transfers the program data to the peripheral device. In the peripheral device, a write control unit updates program data by writing the transferred program data to a data storage unit.

### BACKGROUND OF THE INVENTION

1. Field of the Invention

The present invention relates to an image forming apparatus and a system which includes the image forming apparatus, and, more particularly, to an offer of an effective method which can operate a peripheral device connected to the image forming apparatus.

2. Description of the Related Art

Many image forming apparatuses such as copying machines, particularly a comparatively large-sized image forming apparatuses having advanced functions, can connect peripheral devices, such as finishers and feeders, as an option. For the connected peripheral devices to function, a control program appropriate to each peripheral device becomes necessary. In recent years, to reduce a processing load on the image forming apparatus which is accompanied with the realized advanced functions of the peripheral device, a CPU (Central Processing Unit) and a memory are installed even at the side of the peripheral device. The control program for the peripheral device is stored in the memory installed in the peripheral device and is executed by the CPU installed in the peripheral device.

A manufacturer which provides a peripheral device lines up the various peripheral devices, such as the finishers and the feeders, as described previously, and various machine types in each peripheral device. Then the peripheral device needs to be installed with the control program appropriate for the machine type. Further, because the peripheral device operates in cooperation with an image forming apparatus, the control program which matches a combination of the image forming apparatus with only that type of peripheral device needs to be selected.

Incidentally, if a control program is updated because of function addition, a version of the control program installed in a peripheral device will also be upgraded. In such a case, as a corresponding prior art, for example, a copying machine which has a rewritable memory such as an EEPROM (Electrically Erasable Programmable Read-Only Memory) is disclosed in Japanese Patent Laid-Open Publication No. Hei 5-80602. A program can be added and updated by using the rewritable memory.

To use the EEPROM, however, the memory will be replaced physically with a new one. Accordingly, predetermined time and labor are required for the procurement and replacement work of the memory.

Besides, an art for having a control program sent from a center system is disclosed in Japanese Patent Laid-Open Publication No. 2000-49998. This prior art executes the control program on an image forming apparatus, but does not make reference as to how the control program is sent to the connected peripheral device and made to enter an operable state.

### SUMMARY OF THE INVENTION

The present invention is produced to solve the above problems, and the object is to provide an image forming system which can easily update a program installed in a peripheral device which is connected to an image forming apparatus and a download method in the image forming system.

To achieve the above-described object, an image forming system according to the present invention has an image forming apparatus and at least one peripheral device which is connected to the image forming apparatus and operates in cooperation with the image forming apparatus by executing an installed control program. In this system, the image forming apparatus has a receive processing means for receiving program data downloaded from outside and necessary for cooperation with the peripheral device and transfer control means for transferring the program data received by the receive processing means to the peripheral device.

Moreover, the image forming apparatus has a peripheral device identification means for identifying a type of the peripheral device. The transfer control means judges the peripheral device which corresponds to the received program data and decides a transfer destination of the program data based on the judgment result and the type of the peripheral device identified by the peripheral device identification means.

Further, the image forming apparatus, when a new peripheral device is connected, has a send request means for issuing a send program data request including the type of the peripheral device the peripheral device identification means identified to the outside.

Moreover, the image forming apparatus has a data storage means for saving the program data the receive processing means received.

Further, the image forming apparatus has a transfer instruction input means for instructing transfer timing to the peripheral device. The transfer control means extracts program data from the data storage means and transfers it to the corresponding peripheral device when an input instruction is given from the transfer instruction input means.

Moreover, the image forming apparatus has a notification processing means for notifying information about the peripheral device to the outside. The receive processing means receives the program data which corresponds to the relevant peripheral device downloaded from the outside in accordance with the peripheral device information notified by the notification processing means.

Further, the image forming apparatus has a download control means for responding to a send program data request sent from the outside with a program data send or refusal.

Moreover, the image forming apparatus requests program data which complies with a body type of an image forming apparatus.

Moreover, the peripheral device has a data storage means for storing program data and a write control means for writing the program data transferred from the transfer control means to the data storage means only when the program data corresponds to its own device.

Moreover, an image forming system according to another aspect of the invention has an image forming apparatus which sends and receives data to and from outside and a peripheral device which is connected to the image forming apparatus and operates in cooperation with the image forming apparatus by executing an installed control program. In this system, the peripheral device has a download control means for responding to a send program data request sent from the outside via the image forming apparatus with a program data sending acknowledge or refusal sent to the outside via the image forming apparatus, a data storage means for storing program data, and a write control means for writing the program data sent from the outside via the image forming apparatus to the data storage means by the download control means in accordance with the program data sending request.

Moreover, a download method in an image forming system according to the present invention has an image forming apparatus and a peripheral device which is connected to the image forming apparatus and operates in cooperation with the image forming apparatus by executing an installed control program. In this system, the image forming apparatus has a receiving step for receiving program data downloaded from outside and necessary for cooperation with the peripheral device and a transfer step for transferring the program data received in the receiving processing step to the peripheral device.

Moreover, the transfer step judges the peripheral device which corresponds to the received program and decides a program data transfer destination based on the judgment result and the type of the peripheral device which is connected.

Further, when a new peripheral device is connected, the image forming apparatus has a send request step for issuing a send program data request including the type of the peripheral device to the outside.

Moreover, the image forming apparatus has a data storage step for saving program data received in the receiving step, and the transfer step transfers the program data the data storage step saved at a predetermined time to the peripheral device.

Further, the transfer step transfers the program data when an input instruction is given.

Moreover, the image forming apparatus has a peripheral device information notification step for notifying information about the peripheral device to the outside, and the receiving step receives the program data which corresponds to the relevant peripheral device downloaded from the outside in accordance with a notification by the peripheral device type notification step.

Further, the image forming apparatus has a download control step for responding to a send program data request sent from the outside with a program data send acknowledge or refusal, and the receiving step receives the program data downloaded from the outside in accordance with the sending request in the download control step.

Moreover, the image forming apparatus has a body type notification step for notifying a body type of an image forming apparatus to the outside, and the receiving step receives the program data for the relevant body downloaded from the outside in accordance with a notification in the body type notification step.

Moreover, the peripheral device has a write control step of internally storing program data transferred by the transfer step only when the program data corresponds to itself.

Moreover, a download method in an image forming system according to another invention has an image forming apparatus which sends and receives data to and from the outside and a peripheral device which is connected to the image forming apparatus and operates in cooperation with the image forming apparatus by executing an installed control program. In this system, the peripheral device has a download control step for responding to a send program data request sent from the outside via the image forming apparatus with a program data send acknowledge or refusal to the outside via the image forming apparatus and a write control step for internally writing the program data sent from the outside via the image-informing apparatus in accordance with the data program sending request in the download control step.

According to the present invention, because an attempt was made to transfer program data which corresponds to a peripheral device sent from the outside to the peripheral device, the peripheral device can easily be updated using appropriate program data.

Moreover, when a new peripheral device is connected, because the corresponding program data can be acquired by sending a send program data request including the type of the peripheral device, the peripheral device connected after system installation can easily be set even for operating environment.

Moreover, because a data storage means is provided in an image forming apparatus, program data can be transferred to a peripheral device as required.

Moreover, because a notification processing means is provided, rewriting of a peripheral device program can be executed by an image forming apparatus, which has the initiative. Information which can specify a type of a peripheral device connected to the image forming apparatus or information about an image forming apparatus, or both types of information, is notified to the outside, and proper program data can be downloaded accurately.

Moreover, a download control means for responding to a send program data request from the outside with a sending acknowledge or refusal is provided in an image forming apparatus or a peripheral device, the necessity of program data can be notified to the outside in advance.

Moreover, because a body type notification processing means is provided and information which can specify a type of an information-forming apparatus is notified to the outside, only the program data that matches a combination of the image forming apparatus and a peripheral device can be downloaded from the outside.

### BRIEF DESCRIPTION OF THE DRAWINGS

FIG. 1 is a block diagram showing embodiment 1 of an image forming system according to the present invention;

FIG. 2 is a block diagram showing embodiment 2 of the image forming system according to the present invention;

FIG. 3 is a block diagram showing embodiment 3 of the image forming system according to the present invention;

FIG. 4 is a block diagram showing embodiment 4 of the image forming system according to the present invention;

FIG. 5 is a block diagram showing embodiment 5 of the image forming system according to the present invention; and

FIG. 6 is a block diagram showing embodiment 7 of the image forming system according to the present invention.

### DESCRIPTION OF PREFERRED EMBODIMENTS

Ideal embodiments of the present invention are described below with reference to the drawings. In each embodiment, the same symbol is assigned to the same component.

Embodiment 1.

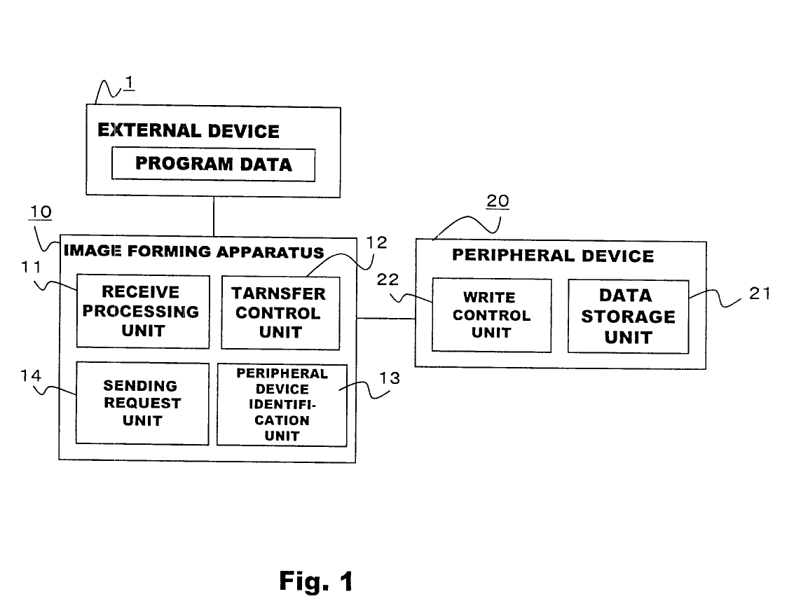

FIG. 1 is a block diagram showing embodiment 1 of an image forming system according to the present invention. FIG. 1 shows an outside 1, an image forming apparatus 10, and a peripheral device 20. The image forming apparatus 10 in this embodiment is assumed to be a copying machine, a facsimile system and a printer, which have advanced functions which are installed in a computer and an image storage device which stores the input image or a multi-functional and can connect to the multiple peripheral devices 20. The peripheral device 20 is composed of a finisher which applies binding processing, folding processing, punching processing, and bookbinding processing to paper on which an image has been formed by the image forming apparatus 10, a feeder which supplies the image forming apparatus with the paper, and a scanner with an automatic document feeding unit which delivers a document to a read unit automatically and reads a document image. The peripheral device 20 in this embodiment is a high performance device which contains a CPU and a memory and executes predetermined processing such as bookbinding by operating in cooperation with the image forming apparatus 10 in accordance with an installed control program. The external device 1 manages an operation control program of the peripheral device 20 and program data necessary for operation control of the peripheral device 20 such as parameters necessary for the operation control.

The peripheral device 20 has a data storage unit 21 which stores program data and a write control unit 22 which writes the sent program data to the data storage unit 21. The data storage unit 21 can be realized with a rewritable memory such as an EEPROM (Electrically Erasable Programmable Read-Only Memory) and a processing function in the write control unit 22 is realized with preinstalled software.

The image forming apparatus 10 has a receive processing unit 11 which receives program data downloaded from the external device 1, a transfer control unit 12 which transfers the program data received by the receive processing unit 11 to the peripheral device 20, a peripheral device identification unit 13 which identifies a type of a peripheral device, and a send request unit 14 which issues a send program data request to the external device 1. The image forming apparatus 10 connects the peripheral device 20 using a dedicated cable, controls printing via the dedicated cable, and transfers the program data as will be described later. The external device 1 and the image forming apparatus 10 can be connected with various means, such as the dedicated cable or a LAN cable and a telephone line.

The peripheral device 20 includes types, such as a finisher and a feeder, as described previously. Moreover, because even the peripheral device of the same type differs in operation and an installed function according to a machine type, the program data, such as a control program and a parameter applied to the peripheral device 20 respectively, need be installed. Further, because the peripheral device 20 operates in cooperation with the image forming apparatus 10 which is connected, the program data needs to apply even to the type of the image forming apparatus 10. That is, the control program which corresponds to a combination of the image forming apparatus 10 and the peripheral device 20 needs be installed in the peripheral device 20.

Moreover, a version needs be upgraded for the purpose of changing a control program itself or program data such as parameters to which the control program refers because of function addition and modification.

A feature in this embodiment is that the program data which corresponds to the type of the peripheral device 20 can be downloaded to the peripheral device 20. The download processing of the program data in this embodiment is described below.

In the image forming apparatus 10, when the RECEIVE PROCESSING UNIT 11 receives program data downloaded from the external device 1 because of initialization or version upgrade, the transfer control unit 12 judges whether the program data is program data which corresponds to the peripheral unit 20 connected to the image forming apparatus 10. The type of the peripheral device 20 is identified by the peripheral device identification unit 13. The transfer control unit 20 judges the above fact by comparing this identified type of the peripheral device 20 and a type of a peripheral device which can be specified according to the downloaded program data. Subsequently, when the transfer control unit 12 judges that the program data is program data which corresponds to the peripheral device 20, the unit transfers the program data to the peripheral device 20.

Moreover, the transfer control unit 12 judges at the same time that the received program data corresponds to the image forming apparatus 10 to which the peripheral device 20 is connected. At that time, the transfer control unit 12 transfers the received program data to the peripheral device 20 when the data corresponds to the image forming apparatus 10.

The write control unit 22 in the peripheral device 20 updates program data by writing the transferred program data to the data storage unit 21. Thus the initialization and version upgrade for the peripheral device 20 terminate.

According to this embodiment, when the program data downloaded from the external device 1 is transferred to the peripheral device 20, because whether or not the program data is program data which corresponds to the peripheral device 20 and the image forming apparatus 10 is checked in advance, proper program data can be stored in the peripheral device 20. Accordingly, the program data stored in the peripheral device 20 can be rewritten by a simple processing operation.

Besides, in the above description and FIG. 1, only a single peripheral device 20 is shown. The multiple peripheral devices 20 of the same type and the same machine type (for example, two finishers of the same machine type) can also be connected, and even a case in which common program data is installed in multiple types of peripheral devices 20 can be assumed. This embodiment can also apply to such a case. The transfer control unit 12 decides (one or more) peripheral devices that matches a type of a peripheral device which can be specified according to the program data among the multiple peripheral devices 20 as a program data transfer destination.

Moreover, as is evident from the above processing, the peripheral device identification unit 13 may identify the type of the peripheral device 20 which is connected until the transfer control unit 12 compares the type of the program data. Accordingly, an identification result may be also tabulated and held. Because the peripheral device 20 can be connected additionally after an image forming system is installed, however, it is appropriate to process the type of the peripheral device 20 which is connected when the type of the program data is compared so that it can be identified each time.

Subsequently, when the peripheral device 20 is connected additionally after an image forming system is installed, the image forming apparatus 10 has the type of the additionally connected peripheral device 20 identified by the peripheral device identification unit 13 and makes the external device 1 send a send program data request to the send request unit 14 including the identified type of the additionally connected peripheral device 20. When the corresponding program data is sent from the external device 1 in accordance with this send request, the image forming apparatus 1 can rewrite the data storage unit 21 of the peripheral device 20 connected additionally in the same manner as above. Even when the new peripheral device 20 is connected in this manner after the image forming system is installed, this processing can be supported immediately.

Embodiment 2.

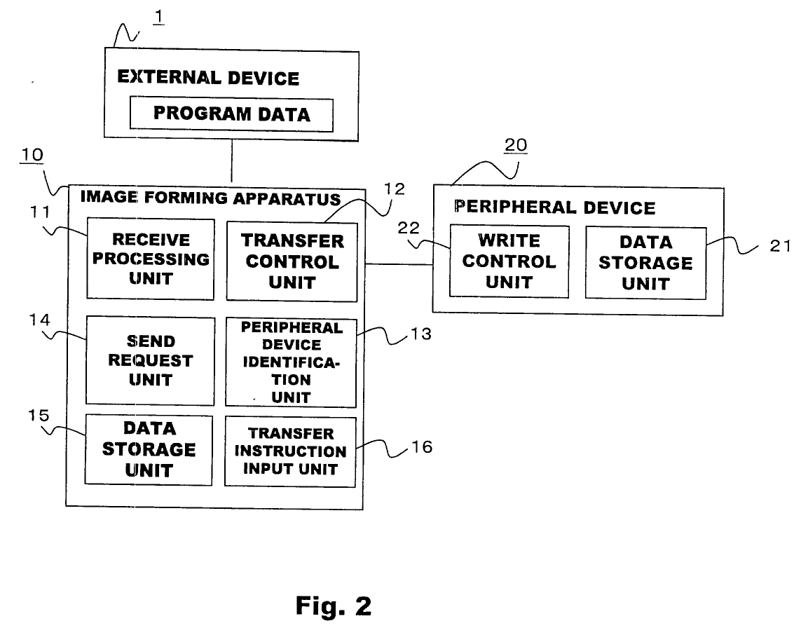

FIG. 2 is a block diagram showing embodiment 2 of the image forming system according to the present invention. The image forming apparatus 10 in this embodiment has a data storage unit 15 which temporarily saves the program data the receive processing unit 11 received and a transfer instruction input unit 16 for issuing a transfer instruction to the peripheral device 20. The data storage unit 15 is realized using a nonvolatile storage device such as a disc drive. The transfer instruction input unit 16 is realized using a touch panel type input/output screen installed in the image forming apparatus 10 or a keyboard and a mouse. Another configuration is the same configuration as embodiment 1. The operation in this embodiment is described below.

In the image forming apparatus 10, when the receive processing unit 11 receives program data downloaded from the external device 1, the unit saves the program data in the data storage unit 15. Subsequently, when a transfer instruction is input from the transfer instruction input unit 16, the transfer control unit 12 transfers program data saved in the data storage unit 15 to the peripheral device 20 which corresponds to the program data. The write control unit 22 in the peripheral device 20 updates program data by writing the transferred program data to the data storage 21.

In the above embodiment 1, program data downloaded from the external device 1 was not saved as is, but transferred to the peripheral device 20. In this embodiment, however, because the data storage unit 15 is provided and the program data was saved once, the program data can be transferred not only when it was downloaded, but also at a subsequent predetermined time. Besides, in this embodiment, the case in which an input instruction was given from the transfer instruction input unit 16 as the time when the transfer control unit 12 starts transfer was described as an example. For example, when the multiple peripheral devices 20 are connected and the saving of the program data for all the peripheral devices 20 in the data storage unit 15 is completed, transfer begins automatically, or when a predetermined time is reached and the image forming processing which is being processed and the processing by the peripheral device 20 terminate, the transfer may also start at another predetermined time.

Embodiment 3.

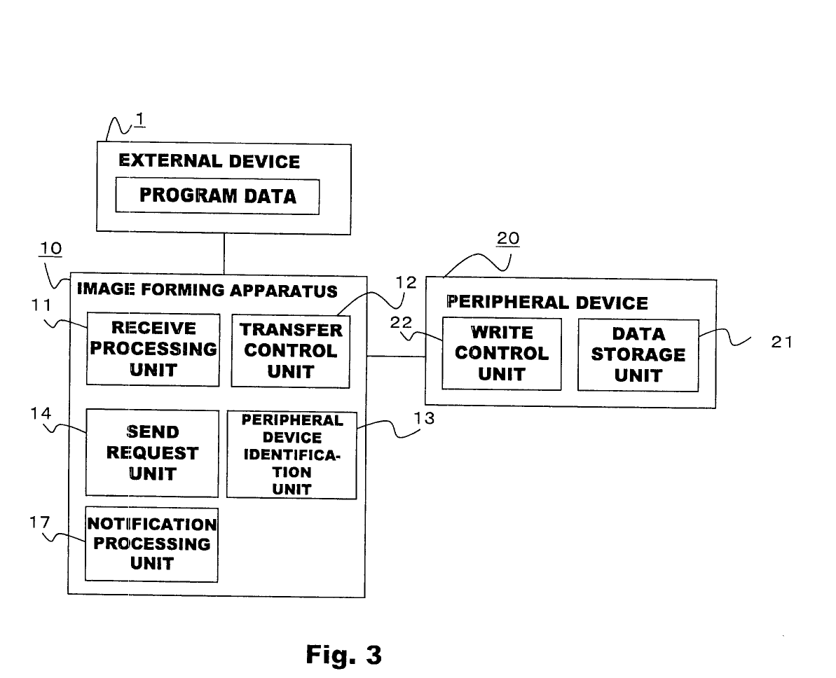

FIG. 3 is a block diagram showing embodiment 3 of the image forming system according to the present invention. The image forming apparatus 10 in this embodiment has a notification processing unit 17 which notifies information about the peripheral device 20 which is connected or information about the image forming apparatus 10, or both these items of information, to the external device 1. Remaining configuration is the same as embodiment 1. The operation of this embodiment is described below.

In the image forming apparatus 10, the notification processing unit 17 notifies information about the peripheral device 20 or information about the image forming apparatus 10, or both these items of information, to the external device 1. The information about the peripheral device 20 can specify a type characteristic of the peripheral device 20 which is connected to the image forming apparatus 10, such as a type of the peripheral device 20 and a version of a control program installed in the peripheral device 20. The type of the peripheral device 20 can be acquired from the peripheral device identification unit 13, but a means of acquiring the version of the control program from the peripheral device 20 or checking and holding the version of the control program at the transfer of the control program becomes necessary. The information about the image forming apparatus 10 is the type of the image forming apparatus 10 and the version of the control program installed in the image forming apparatus 10.

When the sent peripheral device information or the information about the image forming apparatus 10, or the program data which corresponds to the relevant peripheral device is downloaded from the external device 1 in accordance with both the information, subsequently, the receiving processing unit 11 receives the downloaded program data in the same manner as embodiment 1 and the transfer control unit 12 transfers the program data to the peripheral device 20. The write control unit 22 in the peripheral device 22 updates program data by writing the transferred program data to the data storage unit 21.

According to this embodiment, the program of the peripheral device 20 can be rewritten on the initiative of the image forming apparatus 10. Moreover, because the information about the peripheral device 20 connected to the image forming apparatus 10 or the information about the image forming apparatus 10, or both these items of information, is notified to the external device 1, the peripheral device 20 can accurately download the program data necessary for operating in cooperation with the image forming apparatus 10.

Embodiment 4.

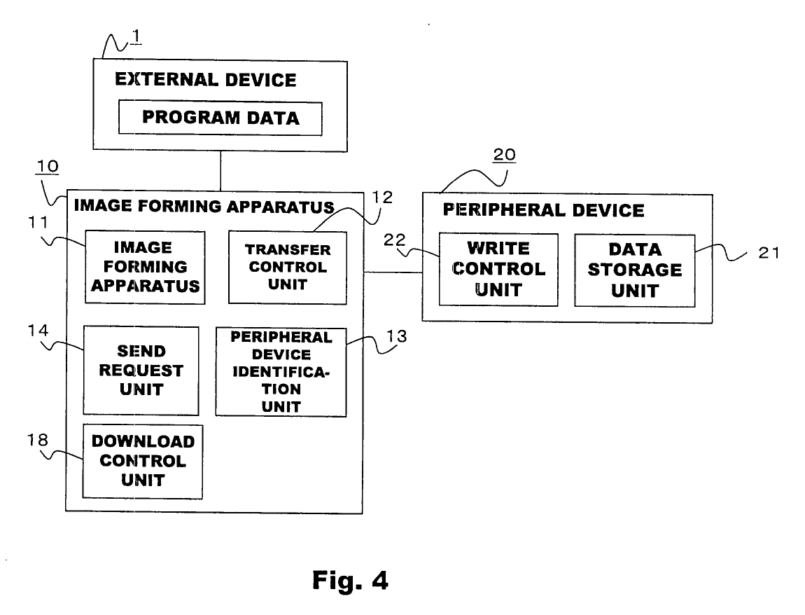

FIG. 4 is a block diagram showing embodiment 4 of the image forming system according to the present invention. The image forming apparatus 10 in this embodiment has a download control unit 18 which responds to a send program data request sent from the external device 1 with a program data sending acknowledge or refusal. Remaining configuration is the same configuration as embodiment 1. The operation in this embodiment is described below. Besides, the external device 1 in this embodiment does not identify the type of the peripheral device 20 connected to the image forming apparatus 10.

First, the external device 1 notifies a send program data request to the image forming apparatus 10 for the reason that a new version of an initialization or control program is not completed. In this send request, a type of a peripheral device to which program data is to be sent or the present or new version of the control program is considered as the information about the peripheral device.

In the image forming apparatus 10, the download control unit 18 judges whether program data the external device 1 requests to send is necessary when the unit receives a send program data request. For example, if a type of a peripheral device is included in the send request, whether or not the peripheral device 20 which corresponds to the type is connected is checked. Moreover, if a version of a control program which is to be sent is included, the version and a version installed currently in the peripheral device 20 are compared and it is checked whether or not the control program of the version included in the send request was acquired. Moreover, it is checked whether or not the program data is adapted to the type of the image forming apparatus 10. That is, it is checked whether program data is adapted to a combination of a type of a peripheral device and an image forming apparatus. As a result, when it was judged that the program data of a send request object is necessary, the download control unit 18 replies with a program data sending acknowledge. On the other hand, when it was judged that the program data is unnecessary, the unit 18 replies with a program data sending refusal.

In case of the sending refusal, processing terminates here, but in case of the sending acknowledge, the external device 1 downloads the relevant program data to the image forming apparatus 10. Subsequent processing may to be the same processing as embodiment 1 and the transfer control unit 12 transfers the downloaded program data to the peripheral device 20. The write control unit 22 in the peripheral device 20 updates program data by writing the transferred program data to the data storage unit 21.

According to this embodiment, when the external device 1 downloads program data, the necessity of the downloaded program data can previously be checked for the image forming apparatus 10.

Embodiment 5.

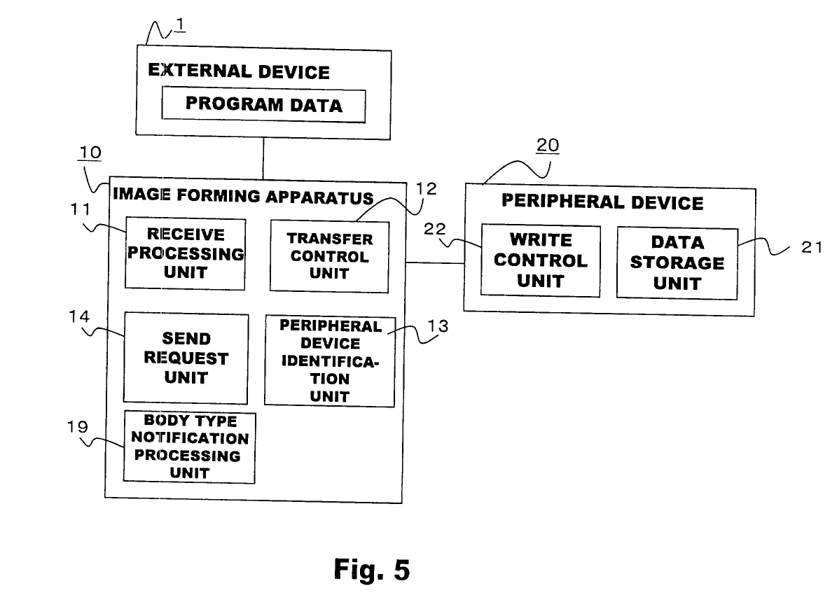

FIG. 5 is a block diagram showing embodiment 5 of the image forming system according to the present invention. The image forming apparatus 10 in this embodiment has a body type notification processing unit 19 which notifies the body type of the image forming apparatus 10 to the outside. Remaining configuration is the same as embodiment 1. The external device 1 in this embodiment does not grasp the type of the image forming apparatus 10. Accordingly, even in such a case, the processing can be supported. The operation in this embodiment is described below.

In the image forming apparatus 10, the body type notification processing unit 19 notifies information about a body of the image forming apparatus 10 to the external device 1. The information about the body of the image forming apparatus 10 can specify the type of the image forming apparatus 10. As described previously, the program data stored in the data storage unit 21 of the peripheral device 20 is specified uniquely according to a combination of the image forming apparatus 10 and the peripheral device 20. This is because there is a machine type that can be connected to the image forming apparatus 10 of a different type according to the peripheral device 20. Accordingly, in this embodiment, the information about the body of the image forming apparatus 10 is sent to the external device 1. Besides, the information about the peripheral device 20 is posted to the external device 1 together with the type of the body by providing the notification processing unit 17 shown in embodiment 3 if the external device 1 does not identify the information.

When the program data from the external device 1 which corresponds to a combination of the relevant image forming apparatus 10 and the peripheral device 20 is downloaded from the external device 1 in accordance with the sent device body information, subsequently, the transfer control unit 12 transfers the program data to the peripheral device 20 in the same manner as embodiment 1. The write control unit 22 in the peripheral device 20 updates program data by writing the transferred program data to the data storage unit 21.

According to this embodiment, only the program data that matches a combination of the image forming apparatus 10 and the peripheral device 20 can be downloaded from the external device 1.

Besides, each component described in each of the above embodiments can be properly combined and used.

Embodiment 6.

This embodiment or a later embodiment is a system peculiar to a component at the side of the peripheral device 20. The peripheral device 20 in this embodiment can be illustrated in the same manner as the configuration shown in each embodiment. This embodiment is peculiar to the processing in the write control unit 22 of the peripheral device 20. Besides, the image forming apparatus 10 may be provided with the RECEIVE PROCESSING UNIT 11 and the transfer control unit 12. The operation in this embodiment is described below.

In the image forming apparatus 10, when the RECEIVE PROCESSING UNIT 11 receives program data downloaded from the external device 1 because of version upgrade, the transfer control unit 12 transfers the program data to all the peripheral devices 20 that are connected. In embodiment 1, a type of the peripheral device 20 is identified and transferred to only the corresponding peripheral device 20, but in this embodiment, a transfer destination is not specified based on the type of such peripheral device 20. Accordingly, the peripheral device identification unit shown in each of the above embodiments is unnecessary.

The write control unit 22 in the peripheral device 20, when program data is transferred, judges whether the program data corresponds to itself and updates program data by writing the program data to the data storage unit 21 when the program data corresponds to itself. Besides, when the program data does not correspond to itself, nothing is performed.

In this embodiment, the appropriateness or inappropriateness of program data can be judged by the peripheral device 20. Besides, the write control unit 22 in this embodiment compares a type of a peripheral device and a type of itself which can be specified according to the program data. The write control unit is similar to a peripheral device identification unit in that processing is executed in accordance with the result. Because the write control unit may support only itself, processing contents and information management are simplified.

Embodiment 7.

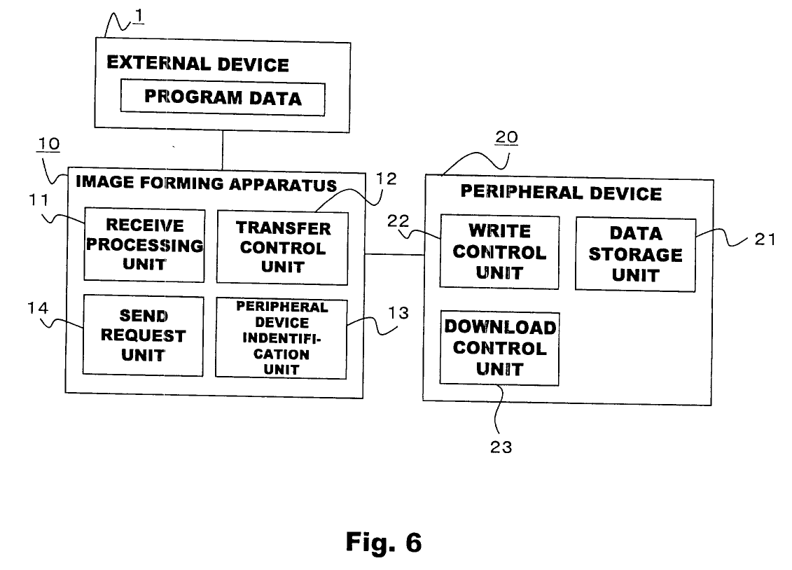

FIG. 6 is a block diagram showing embodiment 7 of the image forming system according to the present invention. The image forming apparatus 10 and the data storage unit 21 and the write control unit 22 for the peripheral device 20 in this embodiment may be the same configuration as embodiment 1. The transfer control unit 12 transfers data bidirectionally. In this embodiment, a download control unit 23 is provided in the peripheral device 20. The download control unit 23 responds to a send program data request sent from the external device 1 with a program data sending acknowledge or refusal to the external device 1. In short, it can be said that a download control unit provided at the side of the image forming apparatus 10 in embodiment 4 is installed at the side of the peripheral device 20. The operation in this embodiment is described below.

First, the external device 1 notifies a send program data request to the image forming apparatus 10 for the reason that a new version of an initialization or control program is not completed. In this send request, a type of a peripheral device to which program data is to be sent or the present or new version of the control program is considered as the information about the peripheral device.

The transfer control unit 12 in the image forming apparatus 10 transfers a send program data request received by the RECEIVE PROCESSING UNIT 11 to the peripheral device 20.

The download control unit 23 in the peripheral device 20 judges whether program data the external device 1 requests to send is necessary. For example, if a type of a peripheral device is included in the send request, whether the type is the same type as itself is checked. Moreover, if a version of a control program to be sent is included, the version and a version installed currently in itself are compared, and it is checked whether or not the control program of the version included in the send request was acquired. As a result, when it is judged that program data of a send request object is necessary, the download control unit 23 replies with a program data sending request via the image forming apparatus 10. On the other hand, when it is judged that the program data is unnecessary, the unit replies with a program data sending refusal.

In case of the sending refusal, processing terminates here, but in case of the sending acknowledge, the external device 1 downloads the relevant program data to the image forming apparatus 10. Subsequent processing may be the same processing as embodiment 1, and the transfer control unit 12 transfers the downloaded program data to the peripheral device 20. The write control unit 22 in the peripheral device 20 updates program data by writing the transferred program data to the data storage unit 21.

According to this embodiment, when the external device 1 downloads program data, the necessity of the downloaded program data can be previously checked for the image forming apparatus 10.

In each of the above embodiments, a method of downloading the program data for each peripheral device 20 the external device 1 manages to the corresponding peripheral device 20 is described above. A component described by being divided into each embodiment can properly be used by being installed in the single image forming apparatus 10 or peripheral device 20.

What is claimed is:

1. An image forming system, comprising:
an image forming apparatus; and
at least one peripheral device which is connected to the image forming apparatus and operates in cooperation with the image forming apparatus by executing an installed control program, wherein the image forming apparatus, including:
a receive processing means for receiving program data downloaded from outside and necessary for cooperation with the peripheral device; and
a transfer control means for transferring the program data received by the receive processing means.

2. The image forming system according to claim 1, wherein
the image forming apparatus comprises a peripheral device identification means for identifying a type of the peripheral device; and
the transfer control means judges whether or not the peripheral device type corresponds to the received program data and decides a transfer destination of the program data based on the judgment result and the type of the peripheral device identified by the peripheral device identification means.

3. The image forming system according to claim 2, wherein the image forming apparatus comprises a send request means for, when a new peripheral device is connected, issuing a send program data request including the type of the peripheral device the peripheral device identification means identified to the outside.

4. The image forming apparatus according to claim 1, wherein the image forming apparatus has a data storage means for saving the program data received by the receive processing means.

5. The image forming system according to claim 4,
wherein the image forming apparatus comprises a transfer instruction input means for instructing transfer timing to the peripheral device and
the transfer control means, when an input instruction is given from the transfer instruction input means, extracts program data from the data storage means and transfers it to the corresponding peripheral device.

6. The image forming system according to claim 1,
wherein the image forming apparatus comprises a notification processing means for notifying information about the peripheral device to the outside and
the receive processing means receives the program data which corresponds to the relevant peripheral device downloaded from the outside in accordance with peripheral device information notified by the notification processing means.

7. The image forming system according to claim 1,
wherein the image forming apparatus comprises a downloading control means for responding to a send program data request sent from the outside with a program data sending acknowledge or refusal.

8. The image forming system according to claim 1, wherein the image forming apparatus requests the program data in accordance with a body type of the image forming apparatus.

9. The image forming system according to claim 1, wherein the peripheral device comprises:
a data storage means for storing program data; and
a write control means for writing the program data only when the program data transferred from the transfer control means corresponds to itself.

10. An image forming system, comprising:
an image forming apparatus which sends and receives data to and from the outside; and
a peripheral device which is connected to the image forming apparatus and operates in cooperation with the image forming apparatus by executing an installed control program, wherein the peripheral device includes:
a download control means for responding to a send program data request sent from the outside via the image forming apparatus with program data sending acknowledge or refusal to the outside via the image forming apparatus;
a data storage means for storing the program data; and
a write control means for writing the program data sent from the outside via the image forming apparatus in accordance with the program data sending acknowledge by the download control means to the data storage means.

11. A download method in an image forming system, comprising:
an image forming apparatus; and
a peripheral device which is connected to the image forming apparatus and operates in cooperation with the image forming apparatus by executing an installed control program, wherein the image forming apparatus includes:
a receiving step for receiving program data downloaded from the outside and necessary for cooperation with the peripheral device; and
a transfer step for transferring the program data the receiving step received to the peripheral device.

12. The download method in the image forming system according to claim 11, wherein the transfer step judges the peripheral device type which corresponds to the received program data and decides a transfer destination of the program data based on the judgment result and the type of the peripheral device which is connected.

13. The download method in the image forming system according to claim 12, wherein the image forming apparatus comprises a send request step for, when a new peripheral device is connected, issuing a send program data request including the type of the peripheral device to the outside.

14. The download method in the image forming system according to claim 11, wherein the image forming apparatus comprises a data storage step for saving the program data received from the receiving step; and
the transfer step transfers the data program the data storage step saved at a predetermined time to the peripheral device.

15. The download method in the image forming system according to claim 14, wherein the transfer step transfers the program data at time when an input instruction is given.

16. The download method in the image forming system according to claim 11, wherein the image forming apparatus comprises a peripheral device information notification step for notifying information about the peripheral device to the outside; and
the receiving step receives the program data which corresponds to the relevant peripheral device downloaded from the outside in accordance with a notification in the peripheral device type notification step.

17. The download method in the image forming system according to claim 16, wherein the image forming apparatus comprises a download control step for responding to a send program data request sent from the outside with a program data sending acknowledge or refusal and
the receiving step receives the program data the downloaded from the outside in accordance with the sending acknowledge in the download control step.

18. The download method in the image forming system according to claim 11, wherein the image forming apparatus comprises a body type notification step for notifying a body type of an image forming apparatus and
the receiving step receives the program data which corresponds to the relevant body downloaded from the outside in accordance with a notification in the body type notification step.

19. The download method in the image forming according to claim 11, wherein the peripheral device comprises a write control step for, only when program data transferred by the transfer step corresponds to itself, internally storing the program data.

20. A download method in an image forming system, comprising:
an image forming apparatus which sends and receives data to and from the outside; and
a peripheral device which is connected to the image forming apparatus and operates in cooperation with the image forming apparatus by executing an installed control program, wherein the peripheral device includes:
a download control step for responding to a send program data request sent from the outside via the image forming device with a program data sending acknowledge or refusal to the outside via the image forming apparatus; and
a write control step for internally storing the program data sent from the outside via the image forming apparatus in accordance with the sending acknowledge in the download control step.
